(19) United States
(12) Patent Application Publication
(10) Pub. No.: US 2013/0087489 A1
(43) Pub. Date: Apr. 11, 2013

(54) DISPOSABLE FILTERING UNIT

(71) Applicant: Yao-Tung Chen, Taoyuan County (TW)

(72) Inventor: Yao-Tung Chen, Taoyuan County (TW)

(21) Appl. No.: 13/451,556

(22) Filed: Apr. 20, 2012

Related U.S. Application Data
(63) Continuation-in-part of application No. 13/317,105, filed on Oct. 11, 2011.

(51) Int. Cl. B01D 35/04

(52) U.S. Cl. 210/232

(57) ABSTRACT

A disposable filtering unit includes a tube having a first connection portion and an outlet respectively located on two ends thereof, and the first connection portion is connected to a faucet body. The tube has a first path unit and a second path unit which has a filtering unit. A valve unit is located on a side of the tube so as to change direction of water flow to guide water to enter from the second path and exits from the outlet via the filtering unit. The tube can be disengaged from the faucet and disposable, and the filtering unit filters water to ensure that the water is clean.

The present invention is a Continuation-In-Part patent application of patent application Ser. No. 13/317,105, and more particularly, to a disposable filtering unit connectable to a faucet to obtain filtered water.

### BACKGROUND OF THE INVENTION

(1) Field of the Invention

(2) Description of the Prior Art

The modern industrialized world generates plenty of pollutants which exist in air and water. For the water pollution, the tap water involves many germs, fine sands, Chloride, heavy metal, and pesticides. The tap water is filtered by way of Reverse Osmosis, Ozone Sterilization, Active-carbon Filtering and Ion Exchange. However, the above mentioned methods and devices for filtering or processing water are expensive, bulky, power-consuming, or replacing filtering cores frequently. Besides, as shown in FIG. 11, another filtering method is equipped with a filterer 102 directly to the outlet 101 of the faucet 100 so that when the tap water passes through the filter 102, the water is filtered. However, the filter occupies space and cannot meet aesthetic purpose. Germs are easily attached to the surface of the filter and the cores have to be replaced regularly. This is an economic burden for the users.

The present invention intends to provide a filtering unit which mitigates the shortcomings of the conventional filtering equipments.

### SUMMARY OF THE INVENTION

The present invention relates to a disposable filtering unit and comprises a tube having a first connection portion and an outlet respectively located on two ends thereof. A path unit is located in the tube and a filtering unit is located in the path unit. An adapter is connected to the tube and has a main tube, a sleeve mounted to the main tube, a resilient member located between the main tube and the sleeve, and a block movably located in the main tube and biased by the resilient member. The main tube has a space. The main tube has a second connection portion which is connected to the first connection portion. A connection unit is a tubular unit and located in the space. The connection unit has a connection end and an insertion respectively on two ends thereof. The connection end is connected with a faucet and the insertion has a groove with which the block is engaged.

By the use of the adapter and the connection unit, the filtering unit can be easily connected with a faucet to form an outlet device and the water flow can be controlled to pass through the filtering unit to be filtered. When the filtering unit is to be replaced, by removal of the adapter and the connection unit, the filtering unit can be disposed.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the disposable filtering unit of the present invention;

FIG. 2 is a cross sectional view to show the path unit of the disposable filtering unit of the present invention;

FIG. 3 is a cross sectional and exploded view of the disposable filtering unit of the present invention and the faucet;

FIG. 4 is a cross sectional view to show the disposable filtering unit of the present invention and the faucet;

FIG. 5 is a cross sectional view to show that connection unit is removed from the adapter of the disposable filtering unit of the present invention;

FIG. 6 is a cross sectional view to show the water flow in the disposable filtering unit of the present invention;

FIG. 7 is a cross sectional view to show another status of the water flow in the disposable filtering unit of the present invention;

FIG. 8 is a second embodiment of the disposable filtering unit of the present invention;

FIG. 9 is a cross sectional view of the second embodiment of the disposable filtering unit of the present invention, wherein the adapter and the connection unit are not yet connected to each other;

FIG. 10 is a cross sectional view of the second embodiment of the disposable filtering unit of the present invention, wherein the adapter and the connection unit are connected to each other, and

FIG. 11 shows the conventional filtering faucet.

### DETAILED DESCRIPTION OF THE PREFERRED EMBODIMENTS

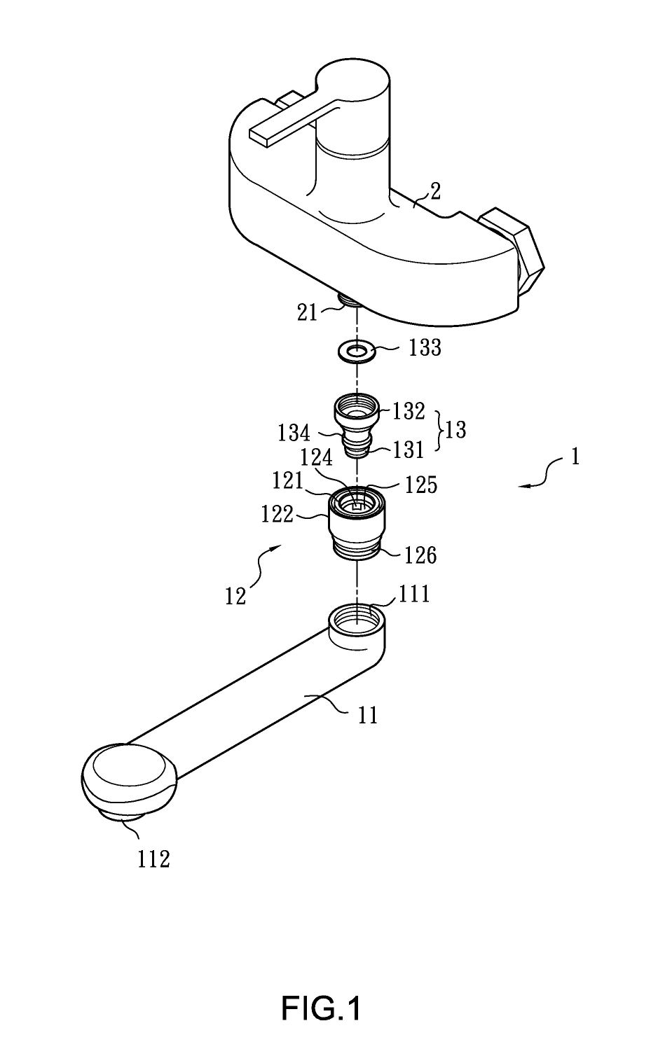

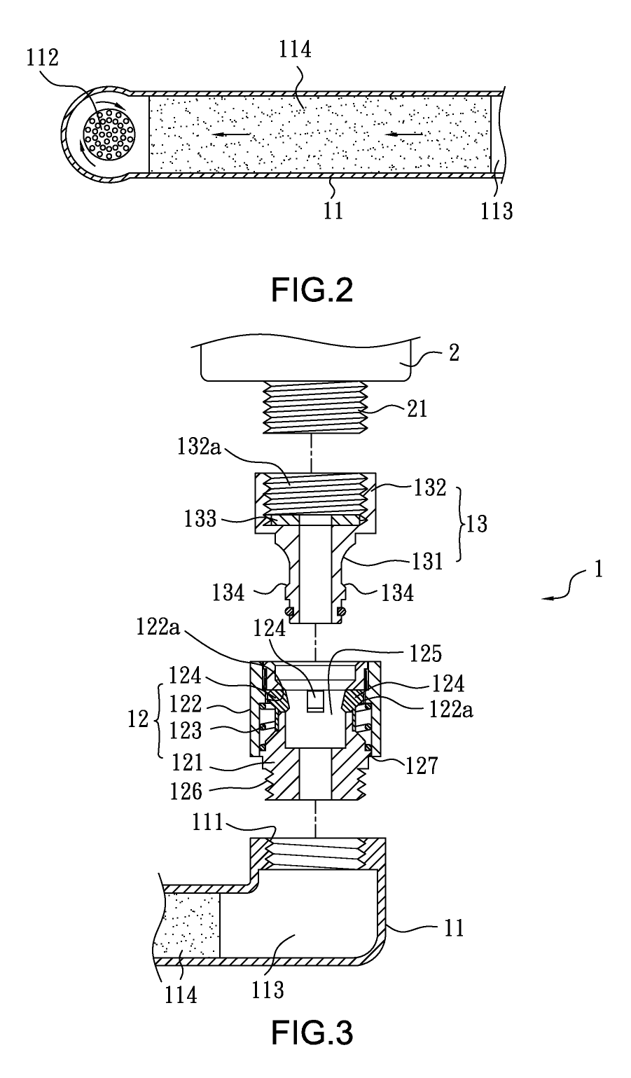

Referring to FIGS. 1 to 4, the disposable filtering unit 1 of the present invention comprises a tube 11, an adapter 12 and a connection unit 13. The tube 11 is a non-permeable tube such as a plastic tube so that the water cannot pass through the wall of the tube 11. The tube 11 has a first connection portion 111 and an outlet 112 respectively located on two ends thereof, and a path unit 113 is located in the tube 11 and a filtering unit 114 located in the path unit 113. The filtering unit 114 can be active carbons, hollow silk films, cottons, coals, de-chlorine agents or Porphyries Andesite. The adapter 12 is connected to the tube 11, has a main tube 121, sleeve 122 mounted to the main tube 121, a resilient member 123 located between the main tube 121 and the sleeve 122, and a block 124 movably located in the main tube 121 and biased by the resilient member 123. The main tube 121 is a hollow tube and has a space 125. The main tube 121 has a second connection portion 126 which is connected to the first connection portion 111. The connection unit 13 is a tubular unit and located in the space 125. The connection unit 13 has a connection end 132 and an insertion 131 respectively on two ends thereof. The connection end 132 is connected with a faucet 2 and the insertion 131 has a groove 134 with which the block 124 is engaged. The connection end 132 has a seal ring 133 mounted thereto. The connection end 132 has inner threads 132a which are connected with the outer threads 21 on the faucet 2.

In this embodiment, the first connection portion 111 is an inner threaded connector and the second connection portion 126 is an outer threaded connector, so that the adapter 12 is connected to the tube 11. The sleeve 122 has a flange 122a extending from the inner periphery thereof and the block 124 contacts the flange 122a. The main tube 121 has a contact portion 127 on the outside thereof and the resilient member 123 is biased between the flange 122a and the contact portion 127. When pulling the sleeve 122 downward, the flange 122a does not contact the block 124 which cannot engaged with the groove 134, so that the adapter 12 can be separated from the connection unit 13.

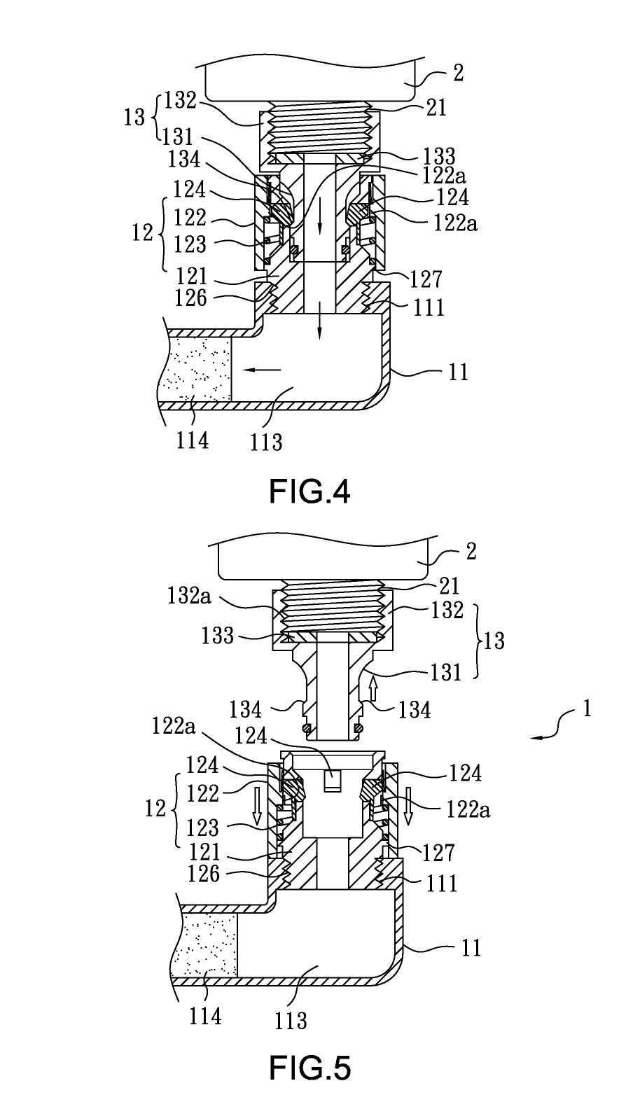

As shown in FIGS. 3 to 5, when assembling, the first and second connection portions 111, 126 and the inner threads 132a of the connection end 132 are connected to the outer threads 21 of the faucet 2, and the connection unit 13 is located in the space 125 of the adapter 12 to precisely engage the block 124 with the groove 134 as shown in FIG. 4. When removing the connection unit 13 from the adapter 12, the sleeve 122 is pulled downward to move the flange 122a downward so that the block 124 is removed from the groove 134 as shown in FIG. 5, so that the adapter 12 is separated from the connection unit 13.

The disposable filtering unit 1 can be easily connected to the faucet 2 to form a water outlet device by using the adapter 12 and the connection unit 13. The filtering unit 114 in the path unit 113 filters the water and the disposable filtering unit 1 meets the requirements of aesthetic purposes. When the filtering unit 114 is to be replaced, by removal of the adapter 12 and installing a new adapter 12 to the tube 11, and connecting the insertion 131 to the space 125, the new water outlet device is formed.

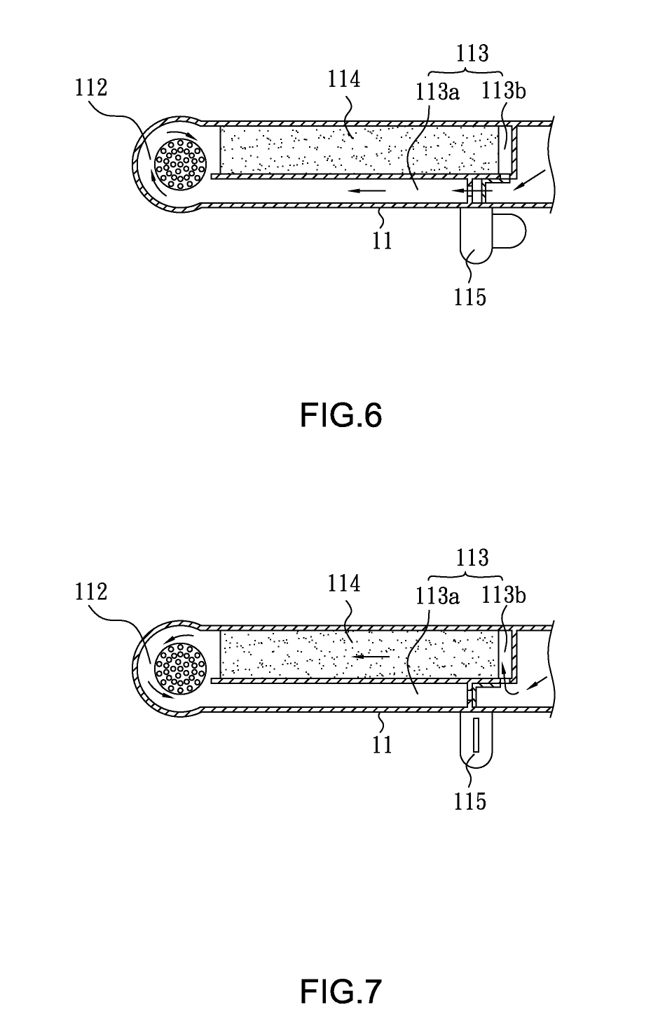

As shown in FIGS. 6 and 7, the second embodiment of the path unit 113 has a first path 113a and a second path 113b which has the filtering unit 114 located therein. A valve unit 115 is located beside the first path 113a and seals the first path 113a so that water enters from the second path 113b and exits from the outlet 112 via the filtering unit 114. By the valve unit 115, the direction of the water flow is controlled to obtain filtered water.

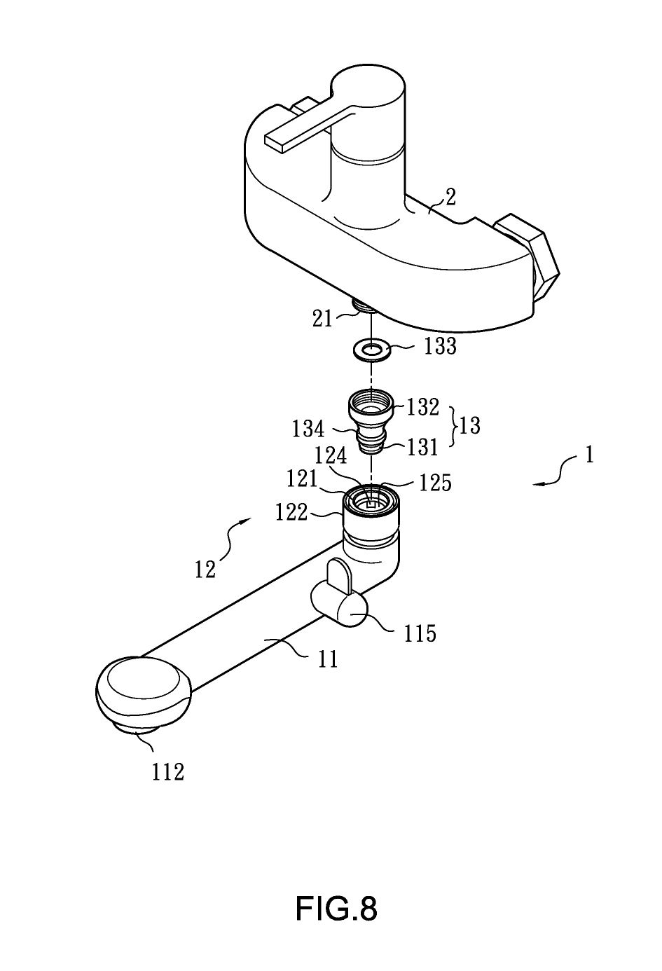

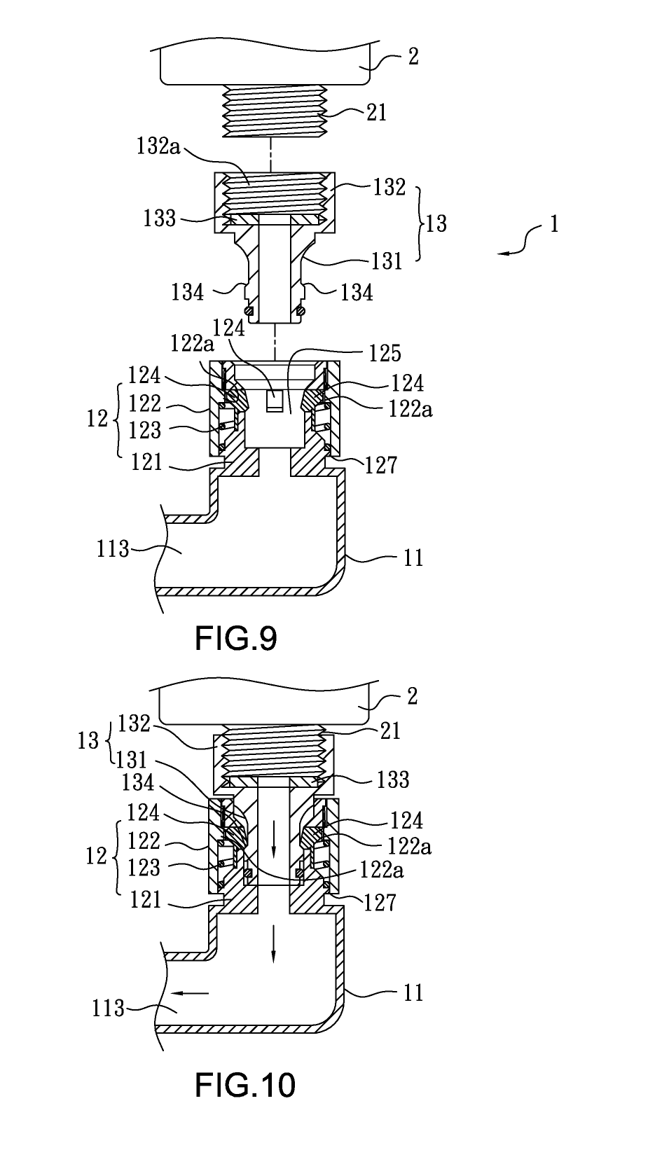

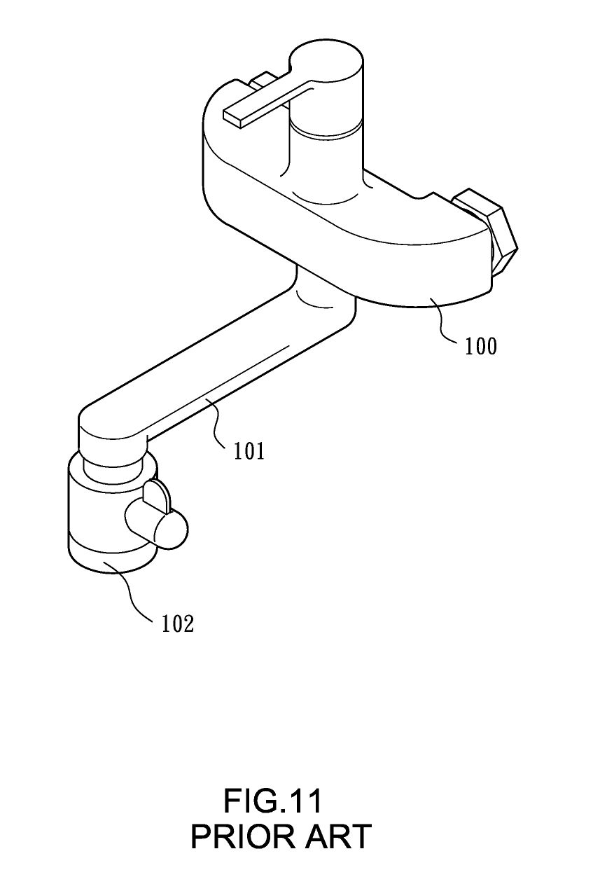

FIGS. 8 to 10 show that the tube 11 and the adapter 12 are made integrally to simplify the manufacturing processes and save manufacturing cost.

The disposable filtering unit 1 can be connected to the faucet 2 as a one-piece combination and filters the water. By the use of the adapter 12 and the connection unit 13, the installation and removal of the disposable filtering unit 1 is easy and convenience.

While we have shown and described the embodiment in accordance with the present invention, it should be clear to those skilled in the art that further embodiments may be made without departing from the scope of the present invention.

What is claimed is:

1. A disposable filtering unit comprising:
a tube having a first connection portion and an outlet respectively located on two ends thereof, a path unit located in the tube and a filtering unit located in the path unit;
an adapter connected to the tube and having a main tube, a sleeve mounted to the main tube, a resilient member located between the main tube and the sleeve, and a block movably located in the main tube and biased by the resilient member, the main tube being a hollow tube and having a space, the main tube having a second connection portion which is connected to the first connection portion, and
a connection unit being a tubular unit and located in the space, the connection unit having a connection end and an insertion respectively on two ends thereof, the connection end adapted to be connected with a faucet and the insertion having a groove with which the block is engaged.

2. The disposable filtering unit as claimed in claim 1, wherein the tube and the adapter are made integrally.

3. The disposable filtering unit as claimed in claim 1, wherein the sleeve has a flange extending from an inner periphery thereof and the block contacts the flange.

4. The disposable filtering unit as claimed in claim 3, wherein the main tube has a contact portion on an outside thereof and the resilient member is biased between the flange and the contact portion.

5. The disposable filtering unit as claimed in claim 1, wherein the path unit has a first path and a second path which has the filtering unit located therein, a valve unit is located beside the first path and seals the first path so that water enters from the second path and exits from the outlet 112 via the filtering unit.

6. The disposable filtering unit as claimed in claim 1, wherein the connection end has inner threads which are adapted to be connected with outer threads on the faucet.

7. The disposable filtering unit as claimed in claim 1, wherein the filtering unit is one or more than one of active carbons, hollow silk films, cottons, coals, de-chlorine agents or Porphyries Andesite.

8. The disposable filtering unit as claimed in claim 1, wherein the tube is a non-permeable tube.

9. The disposable filtering unit as claimed in claim 1, wherein the connection end has a seal ring mounted thereto.

10. The disposable filtering unit as claimed in claim 1, wherein the first connection portion is an inner threaded connector and the second connection portion is an outer threaded connector.
